(19) United States
(12) Patent Application Publication
(10) Pub. No.: US 2025/0105728 A1
(43) Pub. Date: Mar. 27, 2025

(54) EMI REDUCTION DEVICE AND METHOD FOR DC-DC CONVERTER

(71) Applicant: TDK-Lambda (China) Electronics Co., Ltd., Wuxi (CN)

(72) Inventors: Honglei WANG, Wuxi (CN); YueQing Wang, Wuxi (CN)

(73) Assignee: TDK-Lambda (China) Electronics Co., Ltd., Wuxi (CN)

(21) Appl. No.: 18/889,971

(22) Filed: Sep. 19, 2024

(30) Foreign Application Priority Data
Sep. 22, 2023 (CN) 202311234759.1

(51) Int. Cl. H02M 1/44; H02M 3/00

(52) U.S. Cl. CPC H02M 1/44; H02M 3/01

(57) ABSTRACT

An EMI reduction device for a DC-DC converter. The DC-DC converter includes: input voltage terminal; output voltage terminal; plurality of switching elements with an operating frequency thereof being adjusted to modulate an output voltage of the DC-DC converter; and control terminal which changes the operating frequency of the switching elements based on output terminal voltage at output voltage terminal of the DC-DC converter. The EMI reduction device includes: a frequency modulation input unit connected to control terminal and injects fluctuation modulation frequency into the operating frequency of switching elements, wherein the fluctuation modulation frequency is based on output voltage at the output voltage terminal and is set according to desired EMI performance. The EMI reduction device can disperse energy concentrated on frequency point fc and its high frequency harmonic waves to nearby frequency bands, to reduce EMI amplitude at each frequency point, improving the EMI performance of the DC-DC converter.

### TECHNICAL FIELD OF THE INVENTION

The present disclosure relates to switching power supplies, in particular, to an EMI reduction device and method for a frequency modulation DC-DC converter.

### BACKGROUND OF THE INVENTION

A switching power supply is a high-frequency electric energy conversion device, which mainly utilizes power semiconductor devices (such as bipolar transistors, MOS transistors, etc.). Through electronic switching elements are periodically “on” and “off” by means of control circuits, the power semiconductor devices pulse-modulate an input voltage, thereby realizing functions of voltage conversion, adjustable output voltage, and automatic voltage stabilization. For different switching power supply topologies, pulse width modulation (PWM) and frequency modulation are two common control methods. For switching elements, high conversion efficiency and low electromagnetic interference (EMI) are desired.

For the switching power supply controlled by PWM, a mechanism known to effectively reducing an average EMI noise level is direct switching frequency modulation. However, the direct switching frequency modulation which is suitable for reducing the EMI noise in the PWM controlled switching power supply is not suitable for the switching frequency modulation converter. This is because the direct switching frequency modulation is difficult to match the requirement of various loads. For example, the direct switching frequency modulation designed based on a light load condition may cause a large fluctuation in an output voltage under a full load condition.

Accordingly, there is a need for an effective mechanism applicable to the frequency modulation switching power supply, which can reduce the average EMI noise under various load conditions and therefore reducing the size of an EMI filter.

### SUMMARY OF THE INVENTION

The present disclosure has been made in view of the above cases in the prior art, and aims to provide an EMI reduction device and method for a DC-DC converter capable of improving EMI performance.

An aspect of the present disclosure provides an EMI reduction device for a DC-DC converter, wherein the DC-DC converter comprises: an input voltage terminal; an output voltage terminal; a plurality of switching elements with an operating frequency thereof being adjusted to modulate an output voltage of the DC-DC converter; and a control terminal which changes the operating frequency of the switching elements based on an output voltage at the output voltage terminal of the DC-DC converter. The EMI reduction device comprises: a frequency modulation input unit which is connected to the control terminal and injects a fluctuation modulation frequency into the operating frequency, wherein the fluctuation modulation frequency is based on the output voltage at the output voltage terminal and is set according to desired EMI performance.

In the EMI reduction device for a DC-DC converter according to an implementation of the present disclosure, the fluctuation modulation frequency is injected by the frequency modulation input unit via the control terminal. The fluctuation modulation frequency is based on the output voltage at the output voltage terminal and is set according to the desired EMI performance. As such, the EMI reduction device according to the present disclosure can disperse energy concentrated on a frequency point fc and its high frequency harmonic waves, such as 2fc and 3fc, to nearby frequency bands, so as to reduce an EMI amplitude at each frequency point. Since the energy is dispersed to a baseband of the frequency point (i.e., frequency spread), EMI at each frequency point does not exceed a specified limit, implementing the effect of improving the EMI performance.

Moreover, in the EMI reduction device for a DC-DC converter according to another implementation of the present disclosure, the frequency modulation input unit may comprise: a fluctuation output voltage detection unit which detects a fluctuation output voltage at the output voltage terminal of the DC-DC converter as a fluctuation feedback voltage; a fluctuation modulation voltage output unit which outputs a fluctuation modulation voltage corresponding to the fluctuation modulation frequency; and a fluctuation error control unit to which a fluctuation error signal of the fluctuation feedback voltage and the fluctuation modulation voltage is input, and which outputs the fluctuation modulation frequency to the control terminal. In the EMI reduction device according to the present disclosure, in order to make the actual fluctuation output voltage follow the preset fluctuation modulation voltage, the fluctuation error control unit adjusts the operating frequency of the switching elements. As such, the desired frequency spread is implemented.

Moreover, in the EMI reduction device for a DC-DC converter according to another implementation of the present disclosure, the frequency modulation input unit may comprise: a fluctuation modulation voltage output unit which outputs a fluctuation modulation voltage corresponding to the fluctuation modulation frequency. The DC-DC converter may comprise: an output voltage detection unit which detects the output voltage at the output voltage terminal and outputs an output feedback voltage corresponding to the output voltage; and an error control unit to which an additive value of a constant reference voltage and the fluctuation modulation voltage, as well as the output feedback voltage are input, and which outputs a frequency related to the fluctuation modulation frequency to the control terminal.

Moreover, in the EMI reduction device for a DC-DC converter according to another implementation of the present disclosure, a correspondence between the fluctuation modulation voltage and the fluctuation modulation frequency may be: Vmod=Hout_fd*Fsw_d/Gout_f, where Vmod is the fluctuation modulation voltage, Fsw_d is the fluctuation modulation frequency, Gout_f is a transfer function of the DC-DC converter from the output voltage to the operating frequency, and Hout_fd is a transfer function of the output voltage detection unit.

In the DC-DC converter according to this implementation, the DC-DC converter is a feedback control type of DC-DC converter, i.e., it has a feedback circuit for controlling the frequency of the switching elements based on the additive value of the output voltage (including a direct current output voltage and the fluctuation output voltage) of the DC-DC converter and the constant reference voltage. Therefore, instead of providing an additional feedback circuit for controlling the following the preset fluctuation modulation voltage, the preset fluctuation modulation voltage is added to the original feedback control loop of the DC-DC converter. As such, device sharing is implemented, the effects of miniaturization and cost saving are achieved.

Moreover, in the EMI reduction device for a DC-DC converter according to another implementation of the present disclosure, the fluctuation modulation voltage output unit may comprise: an operational amplifier, with a positive phase input terminal thereof being connected to an output terminal via a first resistor, and a negative phase input terminal thereof being connected to a ground terminal via a first capacitor and to the output terminal via a second resistor; a constant voltage power supply, with one terminal thereof being grounded, and the other terminal thereof being connected to the positive phase input terminal of the operational amplifier via a third resistor, and a series circuit of a fourth resistor and a second capacitor, with one terminal thereof being connected to the fluctuation output voltage detection unit or the output voltage detection unit, and the other terminal thereof being connected to a connection point of the second resistor and the first capacitor. Through the fluctuation modulation voltage output unit, the preset fluctuation modulation voltage is injected into the output voltage terminal side of the DC-DC converter, causing the error control unit to adjust the operating frequency of the switching elements. As such, the desired frequency spread is implemented.

Moreover, the EMI reduction device for a DC-DC converter according to another implementation of the present disclosure may further comprise: a current detection unit for detecting an output current of the DC-DC converter. A plurality of current ranges are defined based on the EMI performance of the DC-DC converter, the fluctuation modulation frequency is injected into the switching elements of the DC-DC converter in at least one of the current ranges, and no fluctuation modulation frequency is injected into the switching elements of the DC-DC converter in the current ranges except for the at least one of the current ranges. As such, the activation of the EMI reduction device can be controlled based on the actual EMI performance of the DC-DC converter in different working ranges (current ranges herein). As such, high EMI performance of the DC-DC converter is obtained across all the working ranges.

Moreover, in the EMI reduction device for a DC-DC converter according to another implementation of the present disclosure, the desired EMI performance may be an average value of EMI.

Moreover, in the EMI reduction device for a DC-DC converter according to another implementation of the present disclosure, the DC-DC converter may comprise isolated and non-isolated type of DC-DC converters.

Moreover, in the EMI reduction device for a DC-DC converter according to another implementation of the present disclosure, the DC-DC converter may comprise at least one of an LLC converter, a quasi-resonant boost converter, a quasi-resonant buck converter, and a quasi-resonant flyback converter.

An aspect of the present disclosure provides an EMI reduction method for a DC-DC converter. In the EMI reduction method, an operating frequency of switching elements of the DC-DC converter is adjusted based on an output voltage of the DC-DC converter via a control terminal. A fluctuation modulation frequency is injected into the operating frequency via the control terminal. The fluctuation modulation frequency is based on the output voltage and is set according to a desired EMI performance. As such, the operating frequency of the switching elements of the DC-DC converter may be spread, thereby improving the EMI performance.

Moreover, in the EMI reduction method for a DC-DC converter according to another implementation of the present disclosure, a working range in which EMI improvement is required is determined based on the EMI performance of the DC-DC converter, the fluctuation modulation frequency is injected into the switching elements of the DC-DC converter during the working range, in order to obtain the desired EMI performance, and no fluctuation modulation frequency is injected into the switching elements of the DC-DC converter outside the working range. As such, the activation of the EMI reduction device can be controlled based on the actual EMI performance of the DC-DC converter in different working ranges. As such, high EMI performance of the DC-DC converter is obtained across all the working ranges.

### Effects of the Disclosure

In the EMI reduction device and method for a DC-DC converter of the present disclosure, the fluctuation modulation frequency is based on the output voltage at the output voltage terminal of the DC-DC converter and is set according to the desired EMI performance, so that the frequency of the switching elements of the DC-DC converter is spread, thereby obtaining better EMI performance.

### BRIEF DESCRIPTION OF THE DRAWINGS

FIG. 1 is a functional block diagram schematically illustrating a frequency modulation DC-DC converter.

FIG. 2 is a functional block diagram schematically illustrating a DC-DC converter with a fluctuation error control unit for controlling a fluctuation of an output voltage according to an implementation of the present disclosure.

FIG. 3 is a functional block diagram schematically illustrating a DC-DC converter with an error control unit for controlling an output voltage according to an implementation of the present disclosure.

FIG. 4 is a diagram schematically illustrating an example of a circuit implementation of the fluctuation modulation voltage output unit shown in FIG. 3.

FIG. 5 is a diagram schematically illustrating an example of a unit under test (UUT) of a general LLC converter with output voltage feedback control.

FIG. 6 is a diagram illustrating an EMI test result of the unit under test shown in FIG. 5.

FIG. 7 is a diagram illustrating an example of a fluctuation modulation voltage.

FIG. 8 is a diagram illustrating a fluctuation voltage generated on a DC output voltage after injection of the fluctuation modulation voltage shown in FIG. 7.

FIG. 9 is a diagram illustrating an EMI test result of the unit under test shown in FIG. 4.

FIG. 10(a) is a diagram illustrating EMI test results of the unit under test shown in FIG. 5 under working conditions with outputs of 48 V/1000 W and 48 V/100 W, respectively. FIG. 10(a) illustrates the EMI performance with an output of 48 V/1000 W, i.e., under a full load

FIG. 10(b) is a diagram illustrating EMI test results of the unit under test shown in FIG. 5 under working conditions with outputs of 48 V/1000 W and 48 V/100 W, respectively. FIG. 10(b) illustrates the EMI performance with an output of 48 V/100 W, i.e., under a small load

FIG. 11 is a flowchart illustrating determining whether to activate the EMI reduction device according to a load current.

FIG. 12 is a diagram illustrating an example of further implementing of the function shown in FIG. 11 on the structure of the DC-DC converter shown in FIG. 4.

### BRIEF DESCRIPTION OF THE DRAWINGS

Hereafter, an EMI reduction device and method for a DC-DC converter according to one implementation are described. In the description of each figure, identical or equivalent elements are labeled with the same symbols, and repeated description is omitted sometimes.

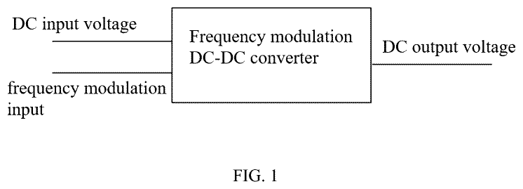

FIG. 1 is a functional block diagram schematically illustrating a frequency modulation DC-DC converter. As shown in FIG. 1, in the DC-DC converter, a working frequency of a switching element of the DC-DC converter is adjusted by means of a control terminal, so that a DC input voltage at an input voltage terminal is converted into a different DC output voltage at an output voltage terminal. As described above, there are currently two control methods for the switching element, which are duty cycle (PWM) modulation and frequency modulation (i.e., width modulation and frequency modulation). In a frequency modulation DC-DC converter, the relationship between a DC output voltage and a DC input voltage is modulated by varying a frequency of occurrence of pulses. The frequency modulation DC-DC converter shown in FIG. 1 may be any converter topology used in a frequency modulation switching power supply.

In a switching power supply, by operating a switching element at a high frequency, the power consumption of the switching element can be reduced, thus greatly improving the conversion efficiency of the power supply. On the other hand, significant electromagnetic interference may be generated by the switching element. Accordingly, an effective mechanism applicable to a frequency modulation switching power supply is needed, which is capable of reducing EMI noise and therefore reducing the size of an EMI filter.

The DC-DC converter according to an implementation of the present disclosure includes: an input voltage terminal; an output voltage terminal; a plurality of switching elements, the frequency of which is adjusted to modulate an output voltage of the DC-DC converter; and a control terminal which changes the operating frequency of the switching elements based on the voltage at the output terminal of the DC-DC converter. The EMI reduction device of the present disclosure includes: a frequency modulation input unit, which is connected to the control terminal and injects a fluctuation modulation frequency into the operating frequency of the switching elements. The fluctuation modulation frequency is based on the output voltage at the output voltage terminal and is set according to the desired EMI performance.

In the EMI reduction device for a DC-DC converter according to an implementation of the present disclosure, the fluctuation modulation frequency is injected by the frequency modulation input unit via the control terminal. The fluctuation modulation frequency is based on the output voltage at the output voltage terminal and is set according to the desired EMI performance. As such, the EMI reduction device of the present disclosure can disperse energy concentrated on a frequency point fc and its high-frequency harmonic waves, such as 2fc and 3fc, to nearby frequency bands, so as to reduce an EMI amplitude at each frequency point. Since the energy is dispersed to a baseband of the frequency point (i.e., frequency spread), EMI at each frequency point does not exceed a specified limit, implementing the effect of improving the EMI performance.

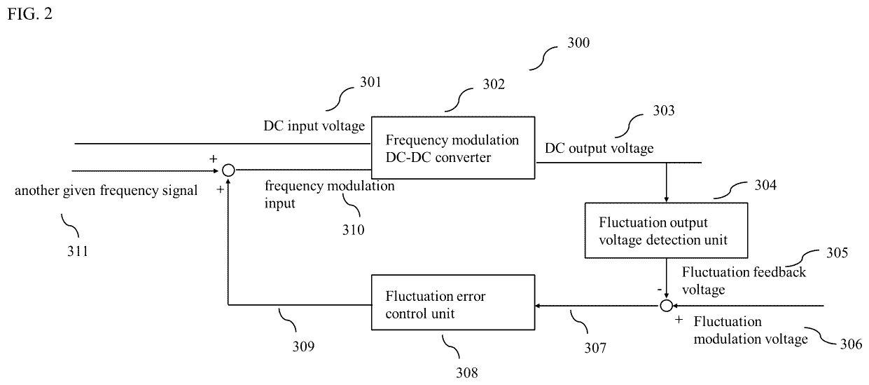

FIG. 2 is a functional block diagram schematically illustrating a DC-DC converter with a fluctuation error control unit for controlling a fluctuation of an output voltage according to an implementation of the present disclosure. As shown in FIG. 2, the frequency modulation input unit includes: a fluctuation output voltage detection unit 304, a fluctuation modulation voltage output unit, and a fluctuation error control unit 308. The fluctuation output voltage detection unit 304 detects a fluctuation output voltage at the output voltage terminal of the DC-DC converter 302 as a fluctuation feedback voltage 305. The fluctuation modulation voltage output unit outputs a fluctuation modulation voltage 306 corresponding to the fluctuation modulation frequency. In the fluctuation error control unit 308, the fluctuation feedback voltage 305 from the fluctuation output voltage detection unit 304 and the fluctuation modulation voltage 306 from the fluctuation modulation voltage output unit are subjected to a differential operation, to obtain a fluctuation error signal 307 as an input of the fluctuation error control unit 308. The fluctuation error control unit 308 functions as a feedback control unit to enable the actual fluctuation feedback voltage 305 to follow the preset fluctuation modulation voltage 306, and outputs the fluctuation modulation frequency 309. The fluctuation modulation frequency 309 is additive with another given frequency signal 311 determined according to a working state of the DC-DC converter, the additive value is input to the control terminal of the DC-DC converter 302 as a frequency modulation input 310.

In the frequency modulation DC-DC converter with a constant DC output voltage, since an operating frequency of the switching element is substantially constant, the EMI performance is poor at the operating frequency and its high-frequency harmonic waves. In the DC-DC converter 300 of the present disclosure, the fluctuation modulation voltage 306 is introduced to the DC output voltage terminal side. The fluctuation error control unit 308 adjusts the operating frequency of the switching elements, so as to make the actual fluctuation feedback voltage 305 follow the preset fluctuation modulation voltage 306. As such, desired frequency spread is implemented under various load conditions, thereby reducing the average EMI noise level.

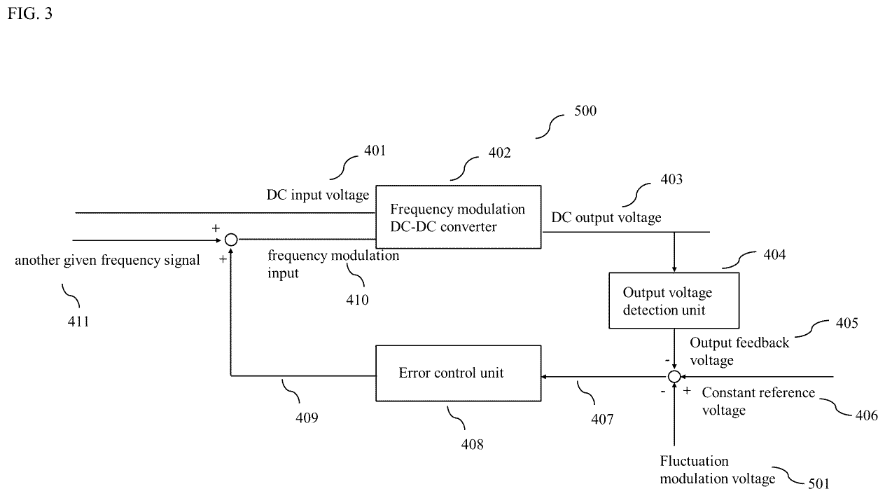

FIG. 3 is a functional block diagram schematically illustrating a DC-DC converter with an error control unit for controlling an output voltage according to an implementation of the present disclosure. The DC-DC converter 500 shown in FIG. 3 is a feedback control type of DC-DC converter, which comprises an output voltage detection unit 404 and an error control unit 408. The output voltage detection unit 404 detects the output voltage 403 at the DC output voltage terminal and outputs an output feedback voltage 405 corresponding to the output voltage 403. The fluctuation modulation voltage output unit outputs the fluctuation modulation voltage 501 corresponding to the desired fluctuation modulation frequency. In the error control unit 408, the input includes an additive value of a constant reference voltage 406 and the fluctuation modulation voltage 501, as well as the output feedback voltage 405. The error control unit 408 outputs a frequency 409 related to the fluctuation modulation frequency, in order to make the output feedback voltage 405 follow the preset fluctuation modulation voltage 501. The frequency 409 related to the fluctuation modulation frequency is additive with another given frequency signal 411 determined according to a working state of the DC-DC converter, and the additive value is input to the control terminal of the DC-DC converter 500 as a frequency modulation input 410.

Hereafter, a correspondence between Vmod, which is the fluctuation modulation voltage 501, and Fsw_d, which is the fluctuation modulation frequency (desired frequency spread) is described.

In a power conversion circuit of the frequency modulation DC-DC converter 402,

$$Fsw\_d = Vout\_d * Gout\_f \qquad ( 1 )$$

wherein Vout_d is a DC output voltage fluctuation at the voltage output terminal of the DC-DC converter caused by Fsw_d, and Gout_f is a transfer function of the frequency modulation DC-DC converter 402 from the output voltage to the operating frequency.

In the output voltage detection unit 404, a relationship between Vout_fd, which is a feedback value of the output voltage fluctuation caused by Fsw_d, and Vout_d, which is the DC output voltage fluctuation caused by Fsw_d is:

$$Vout\_d = Vout\_fd / Hout\_fd \qquad ( 2 )$$

wherein Hout_fd is a transfer function of the output voltage detection unit 404.

As described above, the error control unit 408 functions as a feedback control unit to make the output feedback voltage 405 follow the preset fluctuation modulation voltage 501, i.e., satisfying:

$$V mod = Vout\_fd \qquad ( 3 )$$

From above formulas (1)˜(3), the following may be obtained:
Vmod=Hout_fd*Fsw_d/Gout_f, where Vmod is the fluctuation modulation voltage 501, Fsw_d is the fluctuation modulation frequency, Gout_f is the transfer function of the DC-DC converter 402 from the output voltage to the operating frequency, and Hout_f is the transfer function of the output voltage detection unit 404.

In the DC-DC converter 500 with the EMI reduction device, instead of providing an additional feedback circuit for controlling the following of the preset fluctuation modulation voltage as shown in FIG. 2, the preset fluctuation modulation voltage 501 is added to the original feedback control circuit (i.e., the error control unit 408) of the DC-DC converter. As such, a sharing of devices is implemented, the effects of miniaturization and cost saving are achieved.

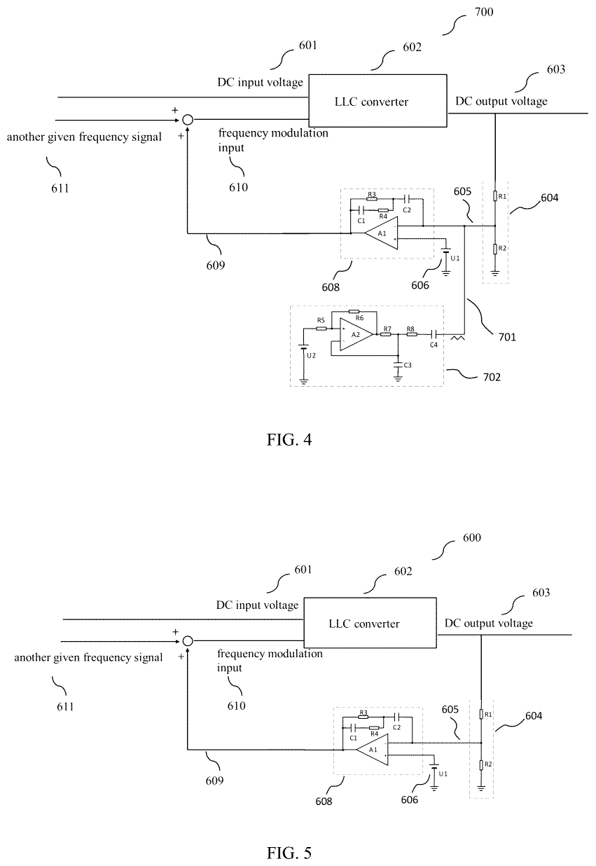

FIG. 4 is a diagram schematically illustrating an example of a circuit implementation of the fluctuation modulation voltage output unit shown in FIG. 3. In FIG. 4, in the DC-DC converter 700 with the EMI reduction device, the following is provided as inputs of the error control unit 608: a constant reference voltage 606, a fluctuation feedback voltage 605 from the fluctuation output voltage detection unit 604, and a fluctuation modulation voltage 701 from the fluctuation modulation voltage output unit 702.

As shown in FIG. 4, the fluctuation modulation voltage output unit 702 includes: an operational amplifier, a positive phase input terminal thereof is connected to an output terminal via a first resistor R6, and a negative phase input terminal thereof is connected to a ground terminal via a first capacitor C3 and the output terminal via a second resistor R7; a constant voltage power supply U2, with one terminal thereof being grounded, and the other terminal thereof being connected to a positive phase input terminal of the operational amplifier via a third resistor R5, and a series circuit of a fourth resistor R8 and a second capacitor C4, with one terminal thereof being connected to the fluctuation output voltage detection unit 604, and the other terminal thereof being connected to a connection point of the second resistor R7 and the first capacitor C3. Through the fluctuation modulation voltage output unit 702, the preset fluctuation modulation voltage 701 is injected into the output voltage terminal side of the DC-DC converter, causing the error control unit 608 to adjust the operating frequency of the switching elements. As such, the desired frequency spread is implemented under various load conditions.

It should be understood that FIG. 4 illustrates a specific implementation of the fluctuation modulation voltage output unit according to the present disclosure. Other implementations, such as a single chip microcomputer, may also be used as long as the above function of the fluctuation modulation voltage of the present disclosure (i.e., outputting a fluctuation modulation voltage corresponding to the desired fluctuation modulation frequency) can be implemented.

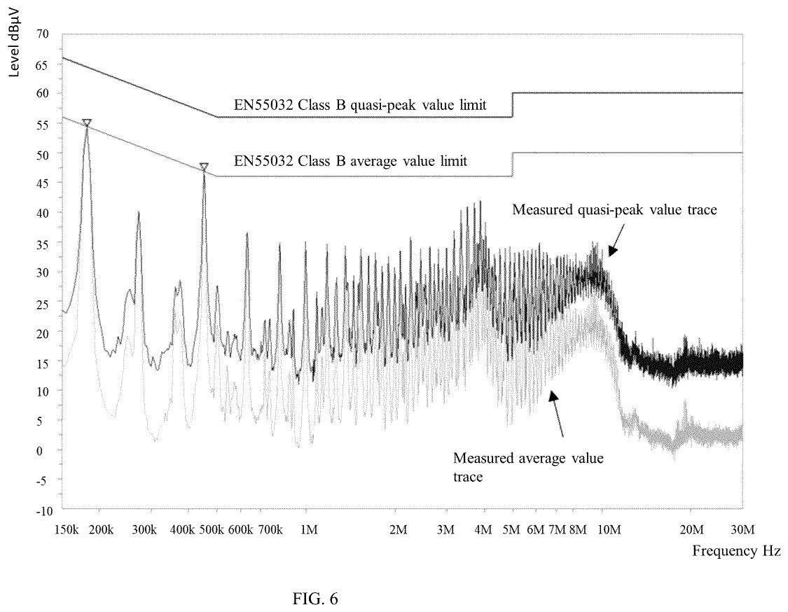

FIG. 5 is a diagram schematically illustrating an example of a unit under test (UUT) of a general LLC converter with output voltage feedback control. The difference between the unit under test shown in FIG. 5 and FIG. 4 is that in the DC-DC converter with the EMI reduction device of the present disclosure shown in FIG. 4, the preset fluctuation modulation voltage 701 is injected into the output voltage side by means of the fluctuation modulation voltage output unit 702.

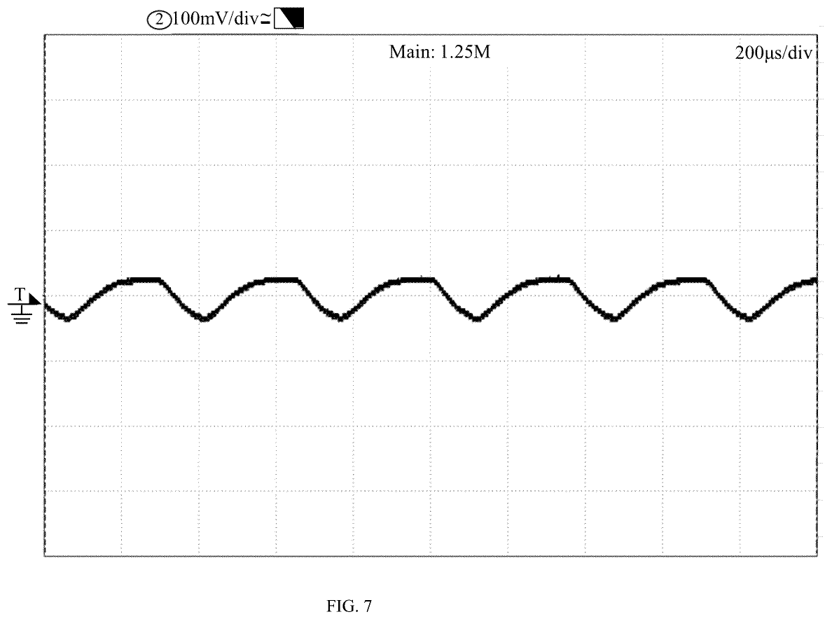

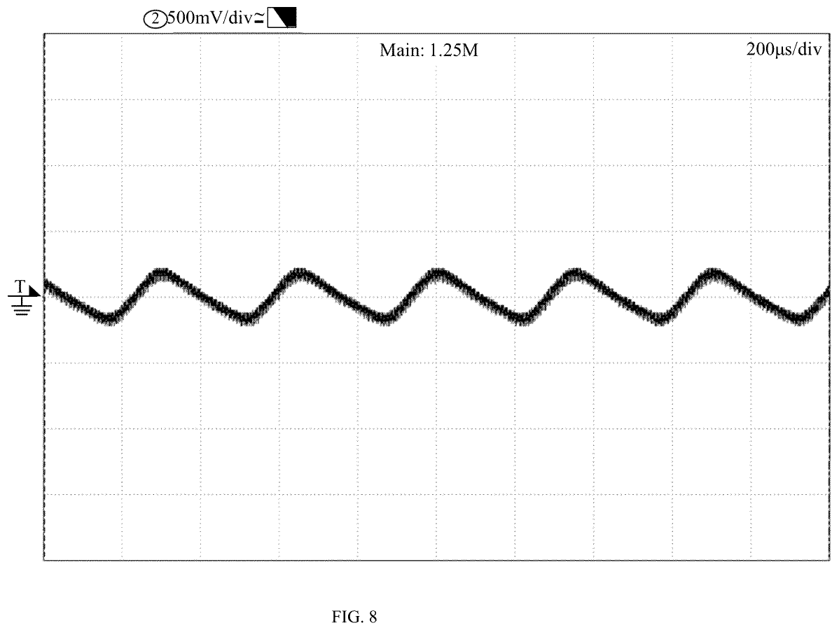

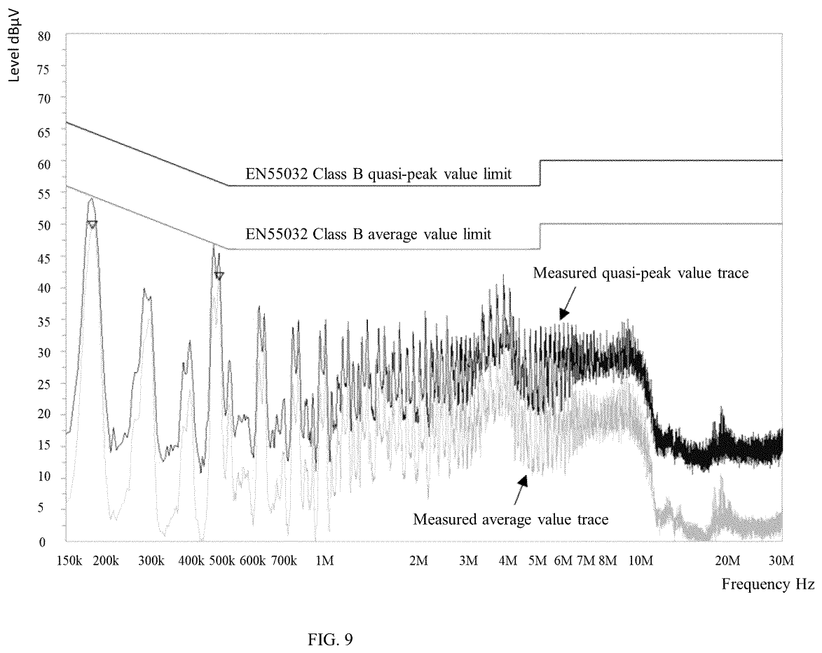

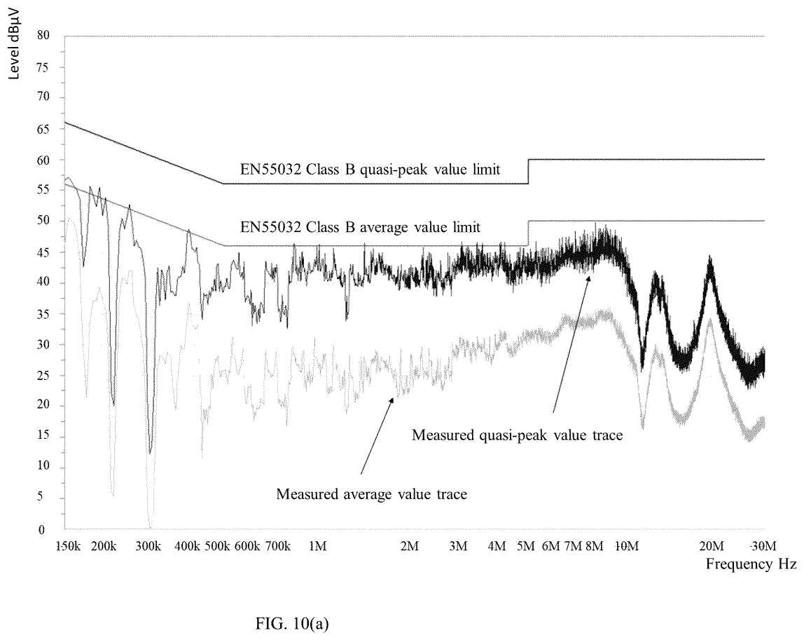

A working mode of the DC-DC converter shown in FIG. 4 and FIG. 5 is set as: input 390 VDC, output 48 V/100 W. EMI is tested according to the requirement of EN55032 Class B, and the results are shown in FIG. 6 and FIG. 9, respectively. In a test, to the DC-DC converter 700 shown in FIG. 4, a fluctuation voltage with a peak-to-peak value of 50 mV as shown in FIG. 7 generated by the fluctuation modulation voltage output unit 702 is applied as the fluctuation modulation voltage 701. As shown in FIG. 8, a fluctuation voltage of 400 mV is generated on the DC output voltage due to the fluctuation modulation voltage as shown in FIG. 7. When the fluctuation voltage increases, the DC-DC converter adjusts the operating frequency, so as to stabilize the output voltage.

In FIG. 6, regulations as well as the traces of DC-DC converter of a quasi-peak value and an average value are shown respectively. As shown in FIG. 6, although the measurement results of the DC-DC converter 600 shown in FIG. 5 meet the regulation of EN55032 Class B, the average noise level around 182 kHz and 455 kHz do not meet the requirement of a 3 dB margin according to a product specification of the UUT.

On the other hand, in the DC-DC converter 700 applied with the EMI reduction device of the present disclosure, as shown in FIG. 9, it is observed that EMI noise spectrum is spread and the average noise level is reduced by about 4 dB, meeting the requirement 3 dB margin. As such, the EMI performance can be improved without changing the EMI filter. According to a comparison of FIG. 6 and FIG. 9, it can be seen that the average EMI noise of the frequency modulation DC-DC converter can be effectively reduced by applying the EMI reduction device of the present disclosure.

It should be noted that the EMI reduction device of the present disclosure may be applied to a frequency modulation DC-DC converter of any topology. That is, the DC-DC converter may include isolated and non-isolated DC-DC converters. In addition, the DC-DC converter may also be any of an LLC converter, a quasi-resonant boost converter, a quasi-resonant buck converter, and a quasi-resonant flyback converter.

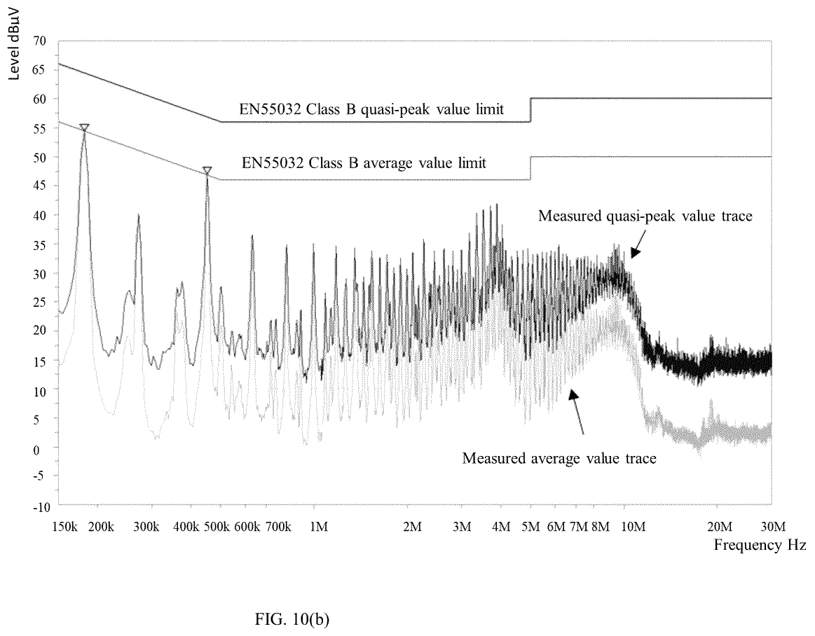

Furthermore, it is also found that the EMI performance of the DC-DC converter varies in different working ranges. FIG. 10(a) and FIG. 10(b) are diagrams illustrating EMI test results of the unit under test shown in FIG. 5 under different working conditions. FIG. 10(a) illustrates the EMI performance with an output of 48 V/1000 W, i.e., under a full load, and FIG. 10(b) illustrates the EMI performance with an output of 48 V/100 W, i.e., under a small load. By comparing FIG. 10(a) and FIG. 10(b), it can be seen that, particularly in a frequency range of 150 k to 400 k, the average EMI performance under the small load is close to the average value regulation of EN55032 Class B and is obviously worse than the average EMI performance under the full load of 48 V/1000 W. Therefore, it is considered to enable the EMI reduction device only in medium and light load working ranges in which the EMI performance is poor, instead of the entire working ranges.

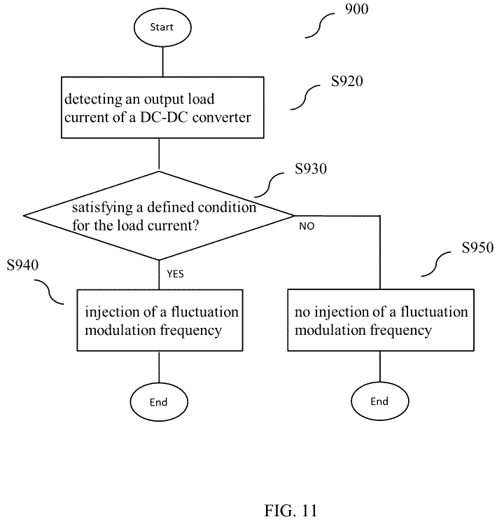

FIG. 11 is a flowchart illustrating determining whether to activate the EMI reduction device according to a load current. As shown in FIG. 11, in step S920, an output load current of the frequency modulation DC-DC converter is detected. In step S930, a judgment is made on the output load current detected in step S920. Step S940 is carried out when the current meets a defined condition, and step S950 is carried out when the current does not meet the defined condition. In step S940, the EMI reduction device of the present disclosure is activated for the frequency modulation DC-DC converter, i.e., the fluctuation modulation frequency is injected. In step S950, the EMI reduction device of the present disclosure is not activated for the frequency modulation DC-DC converter, i.e., no fluctuation modulation frequency is injected. As such, the activation of the EMI reduction device can be controlled based on the actual EMI performance of the DC-DC converter in different working ranges (current ranges herein). As such, high EMI performance of the DC-DC converter is obtained across all the working ranges.

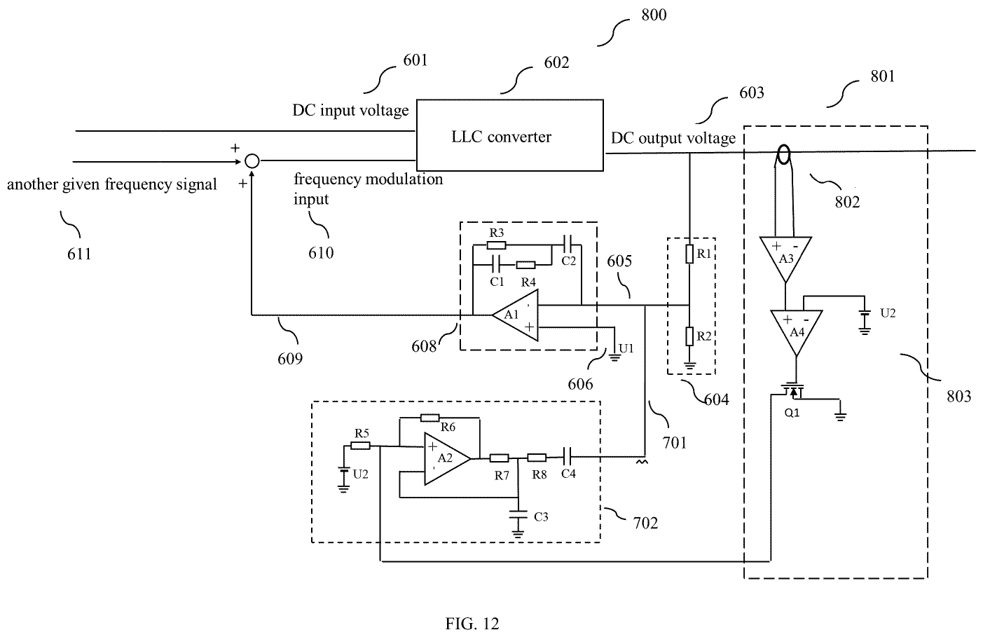

FIG. 12 is a diagram illustrating an example of further implementing of the function shown in FIG. 11 on the structure of the DC-DC converter shown in FIG. 4. In FIG. 12, an output current detection device 802 is provided for detecting an output current. 803 (U2) is configured to set a current threshold to segment the output current. Q1 is on when the detected load current is greater than the current value set by U2, so that a fluctuation voltage generator 702 stops outputting the fluctuation modulation voltage 701, thereby disabling the injection of the fluctuation modulation frequency into the frequency modulation LLC converter device 800. Q1 is off when the detected load current is less than the current value set by U2, so that the fluctuation voltage generator 702 outputs the fluctuation modulation voltage 701, thereby injecting the fluctuation modulation frequency into the frequency modulation LLC converter device 800. That is, a frequency modulation input 610 contains the fluctuation modulation frequency, thereby implementing the desired spread of the operating frequency of the switching elements, reducing the average electromagnetic interference (EMI).

It should be understood that implementations of the present disclosure do not limit a specific current detection method, where either resistive sampling or a current transformer may be employed. Implementations of the present disclosure also do not limit the pre-set current threshold and the number of load working ranges (two working ranges herein), which may be determined according to a noise reduction demand of the average EMI.

The present disclosure further provides an EMI reduction method for a DC-DC converter using the EMI reduction device as described in the above implementations. It should be noted that the EMI reduction method for the DC-DC converter provided by the present disclosure is a method of using the EMI reduction device of the DC-DC converter, which may achieve the same technical effect as that achieved by the implementation of the EMI reduction device. To avoid repetition, the implementation of the EMI reduction method will not be repeated.

Although the present disclosure is described in detail above in conjunction with the drawings and implementations and variations thereof, it should be understood that the above description does not limit the present disclosure in any way. A person skilled in the art may vary and modify the present disclosure as needed without departing from the substantial spirit and scope of the present disclosure, and these variations and modifications fall within the scope of the present disclosure.

1.-11. (canceled)

12. An EMI reduction device for a DC-DC converter, wherein
the DC-DC converter comprises: an input voltage terminal; an output voltage terminal; a plurality of switching elements with an operating frequency thereof being adjusted to modulate an output voltage of the DC-DC converter; and a control terminal which changes the operating frequency of the switching elements based on an output voltage at the output voltage terminal of the DC-DC converter;
the EMI reduction device comprises: a frequency modulation input unit which is connected to the control terminal and injects a fluctuation modulation frequency into the operating frequency, wherein the fluctuation modulation frequency is based on the output voltage at the output voltage terminal and is set according to desired EMI performance.

13. The EMI reduction device for a DC-DC converter according to claim 12, wherein
the frequency modulation input unit comprises:
a fluctuation output voltage detection unit which detects a fluctuation output voltage at the output voltage terminal of the DC-DC converter as a fluctuation feedback voltage;
a fluctuation modulation voltage output unit which outputs a fluctuation modulation voltage corresponding to the fluctuation modulation frequency; and
a fluctuation error control unit to which a fluctuation error signal of the fluctuation feedback voltage and the fluctuation modulation voltage is input, and which outputs the fluctuation modulation frequency to the control terminal.

14. The EMI reduction device for a DC-DC converter according to claim 12, wherein
the frequency modulation input unit comprises: a fluctuation modulation voltage output unit which outputs a fluctuation modulation voltage corresponding to the fluctuation modulation frequency;
the DC-DC converter comprises:
an output voltage detection unit which detects the output voltage at the output voltage terminal and outputs an output feedback voltage corresponding to the output voltage; and
an error control unit to which an additive value of a constant reference voltage and the fluctuation modulation voltage, as well as the output feedback voltage are input, and which outputs a frequency related to the fluctuation modulation frequency to the control terminal.

15. The EMI reduction device for a DC-DC converter according to claim 14, wherein
a correspondence between the fluctuation modulation voltage and the fluctuation modulation frequency is:
$$V mod = Hout\_fd * Fsw\_d / Gout\_f$$
wherein Vmod is the fluctuation modulation voltage, Fsw_d is the fluctuation modulation frequency, Gout_f is a transfer function of the DC-DC converter from the output voltage to the operating frequency, and Hout_fd is a transfer function of the output voltage detection unit.

16. The EMI reduction device for a DC-DC converter according to claim 13, wherein
the fluctuation modulation voltage output unit comprises:
an operational amplifier, with a positive phase input terminal thereof being connected to an output terminal via a first resistor, and a negative phase input terminal thereof being connected to a ground terminal via a first capacitor and to the output terminal via a second resistor;
a constant voltage power supply, with one terminal thereof being grounded, and the other terminal thereof being connected to the positive phase input terminal of the operational amplifier via a third resistor, and
a series circuit of a fourth resistor and a second capacitor, with one terminal thereof being connected to the fluctuation output voltage detection unit or the output voltage detection unit, and the other terminal thereof being connected to a connection point of the second resistor and the first capacitor.

17. The EMI reduction device for a DC-DC converter according to claim 12,
further comprising: a current detection unit for detecting an output current of the DC-DC converter, wherein
a plurality of current ranges are defined based on the EMI performance of the DC-DC converter,
the fluctuation modulation frequency is injected into the switching elements of the DC-DC converter in at least one of the current ranges, and
no fluctuation modulation frequency is injected into the switching elements of the DC-DC converter in the current ranges except for the at least one of the current ranges.

18. The EMI reduction device for a DC-DC converter according to claim 12, wherein
the desired EMI performance is an average value of EMI.

19. The EMI reduction device for a DC-DC converter according to claim 12, wherein
the DC-DC converter comprises isolated and non-isolated type of DC-DC converters.

20. The EMI reduction device for a DC-DC converter according to claim 12, wherein
the DC-DC converter comprises at least one of an LLC converter, a quasi-resonant boost converter, a quasi-resonant buck converter, and a quasi-resonant flyback converter.

21. An EMI reduction method for a DC-DC converter, wherein
an operating frequency of switching elements of the DC-DC converter is adjusted based on an output voltage of the DC-DC converter via a control terminal,
a fluctuation modulation frequency is injected into the operating frequency via the control terminal, and the fluctuation modulation frequency is based on the output voltage and is set according to a desired EMI performance.

22. The EMI reduction method for a DC-DC converter according to claim 21, wherein
a working range in which EMI improvement is required is determined based on the EMI performance of the DC-DC converter,
the fluctuation modulation frequency is injected into the switching elements of the DC-DC converter in the working range, in order to obtain the desired EMI performance, and
no fluctuation modulation frequency is injected into the switching elements of the DC-DC converter outside the working range.
